(19) United States
(12) Patent Application Publication
(10) Pub. No.: US 2013/0186494 A1
(43) Pub. Date: Jul. 25, 2013

(54) QUICK-DISCONNECT COUPLING WITH A HEAT-SENSITIVE CUTOFF FEATURE

(71) Applicants: David Geisel, St. Louis, MO (US); Brian Diel, St. Louis, MO (US)

(72) Inventors: David Geisel, St. Louis, MO (US); Brian Diel, St. Louis, MO (US)

(73) Assignee: M.B. STURGIS, INC., Maryland Heights, MO (US)

(21) Appl. No.: 13/358,238

(22) Filed: Jan. 25, 2012

(51) Int. Cl. F16L 37/00

(52) U.S. Cl. 137/798

(57) ABSTRACT

A quick-disconnect coupling which provides connection between a fuel source and a gas appliance. The quick-disconnect coupling is heat-sensitive for preventing the flow of gas to the gas appliance/equipment when it is subjected to high temperatures. This is accomplished by forming the ball bearings and/or the sleeve of a suitable thermally reactive material which melts or softens when subjected to high temperatures. Thus, if the melting point of the ball bearings and/or the sleeve is exceeded when the quick-disconnect coupling is connecting the fuel source to a nozzle, the heat will cause the thermally reactive material to soften, allowing the poppet spring to extend, pushing the poppet to seal against the flow of gas.

### BACKGROUND OF THE INVENTION

The present invention relates generally to quick-disconnect couplings and, more particularly, to a quick-disconnect coupling which is especially adapted for use in applications involving a combustible gas (e.g., gasoline, ethanol, hydrogen cells, propane or natural gas), the coupling having a heat-sensitive cutoff feature for shutting off the flow of gas when subjected to high temperatures.

Many appliances and machines use a gas or combination of gases as fuel. For example, gas-fueled, outdoor barbeque grills are typically fueled by propane or natural gas contained in pressurized, refillable fuel tanks. Replacing empty tanks continues to be a relatively burdensome and time-consuming process, usually involving unscrewing the various component parts of the connection between the tank and the fuel line to the appliance and/or equipment, appropriately positioning a new tank and then screwing the component parts together once more. Furthermore, improper reassembly of the connection may result in dangerous gas leakage from the tank.

The inventors of the present invention have previously developed a quick-disconnect coupling with a heat-sensitive cutoff feature for use in connecting a tank of pressurized gas with a gas appliance, such as an outdoor gas grill, as disclosed in U.S. Pat. No. 4,290,440, issued on Sep. 22, 1981. This earlier device was disclosed as using a coupling comprised of interengageable plug and socket components, the latter component having a passage therethrough, a valve seat in the passage and a poppet valve in the passage comprising a valve stem and a sealing member soldered on the stem and engageable with the valve seat. A spring was engageable with the sealing member for biasing the poppet valve to a closed position for blocking flow through the passage. When inserted into the socket chamber, the plug component engaged the valve stem for forcing the poppet valve open. Where the temperature of the coupling rose to a temperature above the melting point of the solder bond between the sealing member and the valve stem, the sealing member would slide on the stem into engagement with the valve seat for cutting off flow therepast.

### SUMMARY OF THE INVENTION

The present invention is directed to a quick-disconnect coupling which provides a connection between a fuel source and a gas appliance, equipment or other device which may utilize gas (hereinafter collectively referred to as a “gas appliance” or just an “appliance”). A regulator may also be present between the fuel source and the gas appliance. In one embodiment, the present invention has a socket component for operable connection to the fuel source, where the socket component is associated with a first cavity. The quick-disconnect coupling may also have a second cavity by which the quick-disconnect coupling facilitates the connection of the fuel source to the gas appliance, allowing fuel to flow freely from the fuel source to the gas appliance. The quick-disconnect coupling may be removeably attached to the fuel source via the socket component and is removeably attached to a nozzle associated with a fuel line and/or regulator connected to the appliance via the second cavity. In yet another embodiment, the present invention may have a sleeve for operable connection to the fuel source. The quick-disconnect coupling is removeably attached to the fuel source in the cavity via the sleeve and is removeably attached to the regulator via the socket component.

The quick-disconnect coupling is comprised of a body having the socket component associated with a first cavity located at the proximate end, and the second cavity located at the distal end. The socket component may be comprised of a first cylindrical shell having a threaded passage leading to the first cavity. The first cavity may contain a poppet spring, a poppet and a poppet seal. The poppet may be further comprised of a cone-shaped member such that the narrow end of the poppet extends from the first inner cavity into a second inner cavity via a through-hole. The poppet may be biased such that the poppet seal engages with inner walls of the first inner chamber to create a seal to prevent the flow of gas from the first cavity to the second cavity via the through-hole when not connected to the gas appliance.

The cavity may be comprised of a second cylindrical shell having a plurality of uniformly spaced ball bearing cavities therein for releasably securing a plurality of ball bearings within the second cylindrical shell of the body. The sleeve is preferably moveably positioned around the body, and can be moved axially along the body. The sleeve is biased toward a first position in which the sleeve forces at least a portion of the ball bearings into the cavity. In a second position, the sleeve no longer forces the ball bearings into the cavity, thereby allow the ball bearings to retreat from the cavity.

To connect a nozzle to the quick-disconnect coupling, the sleeve is moved into the second position such that the ball bearings can retreat from the cavity when the nozzle is inserted into the cavity. Once the nozzle is inserted, the sleeve is allowed to return to the first position where it forces the ball bearings into the cavity. In the cavity, the ball bearings engage with a portion of the nozzle therein to secure the nozzle in place within the cavity.

When secured in place by the ball bearings, the nozzle presses up against the narrow end of the poppet which, as discussed above, extends into the second cavity. The nozzle pushes against the narrow end of the poppet, forcing it slightly back into the first cavity, thereby moving the poppet seal away from the inner wall of the first cavity. This action breaks the seal between the first and second cavities, allowing fuel to flow therethrough.

The quick-disconnect coupling is heat-sensitive for preventing the flow of gas to a gas appliance when it is subjected to high temperatures. This is accomplished by forming the ball bearings and/or the sleeve of a suitable material which melts or softens at a given temperature. Thus, if the melting point of the ball bearings and/or the sleeve is exceeded when the quick-disconnect coupling is connected to the nozzle, the heat will cause the material to melt or soften, releasing the nozzle and allowing the poppet spring to push the poppet seal into engagement with the first inner chamber once more, thereby cutting off the flow of gas to the gas appliance. Specific advantages and features of the present assembly will be apparent from the accompanying drawings and the description of several illustrative embodiments of the present invention.

### DESCRIPTION OF THE DRAWINGS

FIG. 1 illustrates a front plan view of a gas appliance and a fuel source connected with an example embodiment of a quick-disconnect coupling.

FIG. 2 is an exploded perspective view of an example quick-disconnect coupling of FIG. 1.

FIG. 3 is an axial cross-sectional view of an example quick-disconnect coupling of FIG. 1 as configured to receive a nozzle.

FIG. 4 is an axial cross-sectional view of an example quick-disconnect coupling of FIG. 1 as having received and engaged with a nozzle.

FIG. 5 is a transverse cross-sectional view of an example quick-disconnect coupling of FIG. 1.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION

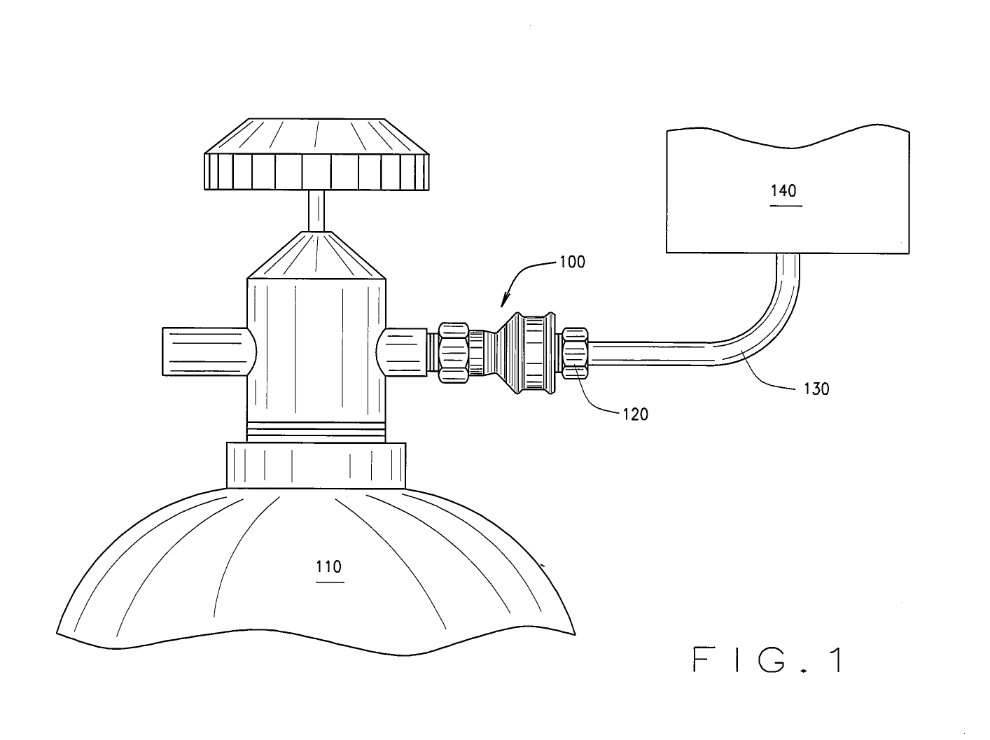

Referring now to the drawings, more particularly FIG. 1, a quick-disconnect coupling 100 is shown connecting a fuel source 110 to a nozzle 120 (which may include a regulator), the nozzle 120 being operably attached to a gas appliance 140 by a fuel line 130.

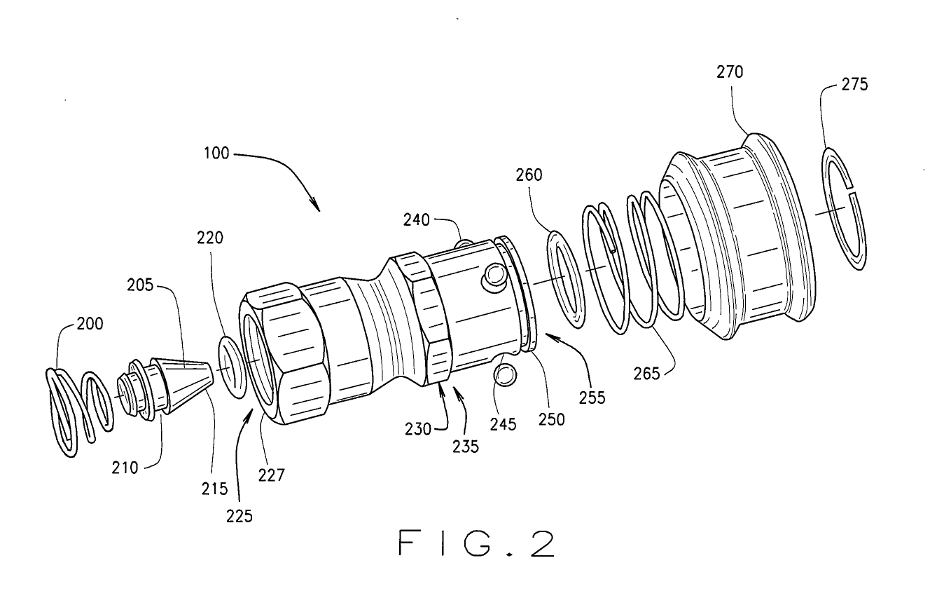

Referring to FIGS. 2-4 the quick-disconnect coupling 100 may have a first cavity 225 associated with a socket component 227 for operable connection to the fuel source 110. The coupling 100 may also have a second cavity 255 by which the quick-disconnect coupling 100 facilitates the connection of the fuel source 110 to the gas appliance 140, allowing fuel to flow freely from the fuel source 110 to the gas appliance 140. The quick-disconnect coupling 100 may be removeably attached to the fuel source 110 via the socket component 227 and is removeably attached to the nozzle 120 via the cavity 255. In yet another embodiment, the present invention may have a cavity 255 for operable connection to the fuel source 110 and a socket component 227 by which the quick-disconnect coupling 100 facilitates the connection of the fuel source 110 to the gas appliance 140, allowing fuel to flow freely from the fuel source 110 to the gas appliance 140. The quick-disconnect coupling 100 is removeably attached to the fuel source 110 via the cavity 255 and is removeably attached to the regulator 120 via the socket component 227.

The quick-disconnect coupling 100 is comprised of a body 230 having a first cavity 225 located at the proximate end and a second cavity 255 located at the distal end. The first cavity 225 may be defined by a first cylindrical shell and may include a socket component 227 having a threaded passage 300 therein. A poppet 205 may be positioned within the first cavity 225. The poppet 205 may be comprised of a cone-shaped member 215 in the form of a conical frustum, the wider end of the cone-shaped member 215 including a channel 210 into which a poppet seal 220 is seated. The narrow end of the cone-shaped member 215 may extend through a through-hole 232 in the body 230, connecting the first cavity 225 with the second cavity 255. The poppet 205 is capable of axial movement along the longitudinal axis of the body 230, such movement being facilitated by a poppet spring 200. The poppet spring 200 biases the narrow end 215 of the poppet 205 through the through-hole 232 such that the poppet seal 220 engages with the inner wall(s) of the body 230 proximate through-hole 232 to form an air- and gas-tight seal between the first and second cavities 225, 255. The narrow end 215 of poppet 205 is positioned for engaging with a nozzle 120 when the nozzle is retained in said second cavity 255. The poppet 205 may be comprised of a suitable material, such as a metal or metal alloy including brass, bronze, copper, zinc, tin or aluminum.

In one embodiment, the nozzle 120 is inserted into the second cavity 255, engaging the narrow end of the cone-shaped member 215, and forcing the poppet 205 back and moving the poppet seal 220 away from the inner wall(s) of the body 230 proximate through-hole 232. By breaking the seal between the poppet seal 220 and the inner wall(s) of the body 230, the first and second cavities 225, 255 are in gaseous communication with one another and gas is allowed to flow from the first cavity 225, through the through-hole 232, into the second cavity 255 and into the nozzle 120 for transport to the gas appliance 140. In certain embodiments, the nozzle 120 may be operably attached to a regulator, the fuel line 130 or the gas appliance 140.

The body 230 may further include a second cavity 255 defined by a second cylindrical shell. The second cylindrical shell of the body 230 preferably has at least one uniformly spaced ball bearing cavity 245, each for operably securing a ball bearing 240 within the second cavity 255 of the body 230. The ball bearing 240 allows for securing the nozzle 120 in the second cavity 255 upon insertion therein. The second cylindrical shell of the body 230 may be further comprised of a groove element 250 for securing a sleeve ring 275 to the body 230 and a ridge element 235 which functions in conjunction with the sleeve ring 275 as retaining elements to operably attach a sleeve 270 to the body 230. The sleeve 270 may be operably attached to the second cylindrical shell of the body 230 for axial movement facilitated by a sleeve spring 265.

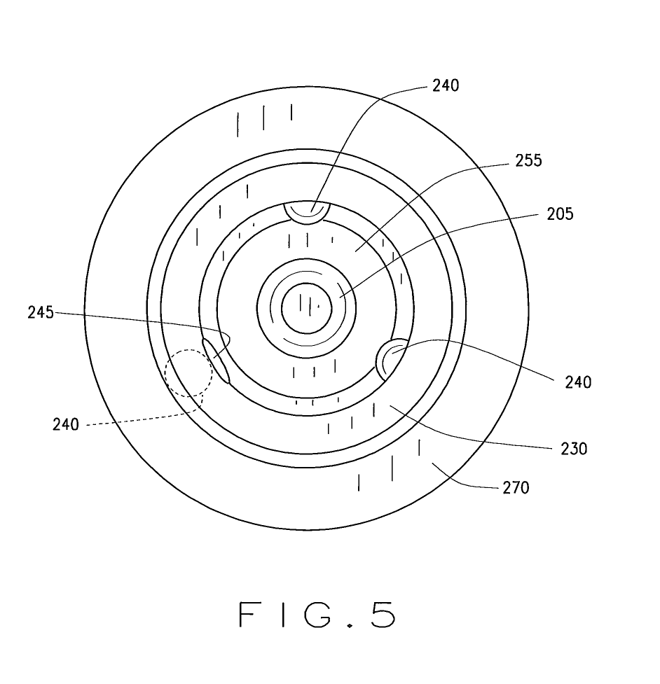

As illustrated in FIG. 5, the plurality of uniformly spaced ball bearing cavities 245 may be included, and may act as retaining elements to operably secure ball bearings 240 within the body 230. Ball bearings 240 preferably are allowed some amount of travel within the ball bearing cavities 245, such that ball bearings 240 may at least partially extend into the second cavity 255, or may at least partially retract from second cavity 255. In one embodiment, the ball bearings 240 may be comprised of a suitable metal or metal alloy, such as brass, bronze, copper, zinc, tin or aluminum, for operably securing the quick-disconnect coupling 100 to the nozzle 120. In another embodiment, the ball bearings 240 may be comprised of a suitable thermally reactive material, such as wax, rubber, resin, neoprene, nylon, PVC, polystyrene, polyethylene, polypropylene, polyacrylonitrile, PVB or silicone. Any suitable thermally reactive material, which has a melting point when subjected to high temperatures, specifically, temperatures below about 1000 degrees Fahrenheit, may be used. Ball bearings 240 comprised of a thermally reactive material have the additional advantage that the ball bearings 240 may, due to their composition, melt or soften when subjected to high temperatures, resulting in the disengagement of the quick-disconnect coupling 100 from the nozzle 330, preventing the flow of gas to gas appliance 140.

The sleeve 270 may be operably attached to the body 230 for axial movement therealong facilitated by a sleeve spring 265. In one embodiment, the sleeve 270 may be comprised of a suitable metal or metal alloy, such as brass, bronze, copper, zinc, tin or aluminum, for operably securing the quick-disconnect coupling 100 to the nozzle 120. In another embodiment, the sleeve 270 may be comprised of a suitable thermally reactive material, such as wax, rubber, resin, neoprene, nylon, PVC, polystyrene, polyethylene, polypropylene, polyacrylonitrile, PVB or silicone. Any suitable thermally reactive materials, which has a melting point when subjected to high temperatures, specifically, temperatures below about 1000 degrees Fahrenheit, may be used, may be used. Sleeve 270 comprised of a thermally reactive material has the additional advantage that the sleeve 270 may, due to its composition, melt or soften when subjected to high temperatures, resulting in the disengagement of the quick-disconnect coupling 100 from the nozzle 330, preventing the flow of gas to gas appliance 140. The sleeve 270 and/or the ball bearings 240 may individually or jointly form a securing mechanism which secures the nozzle 120 within the second cavity 255.

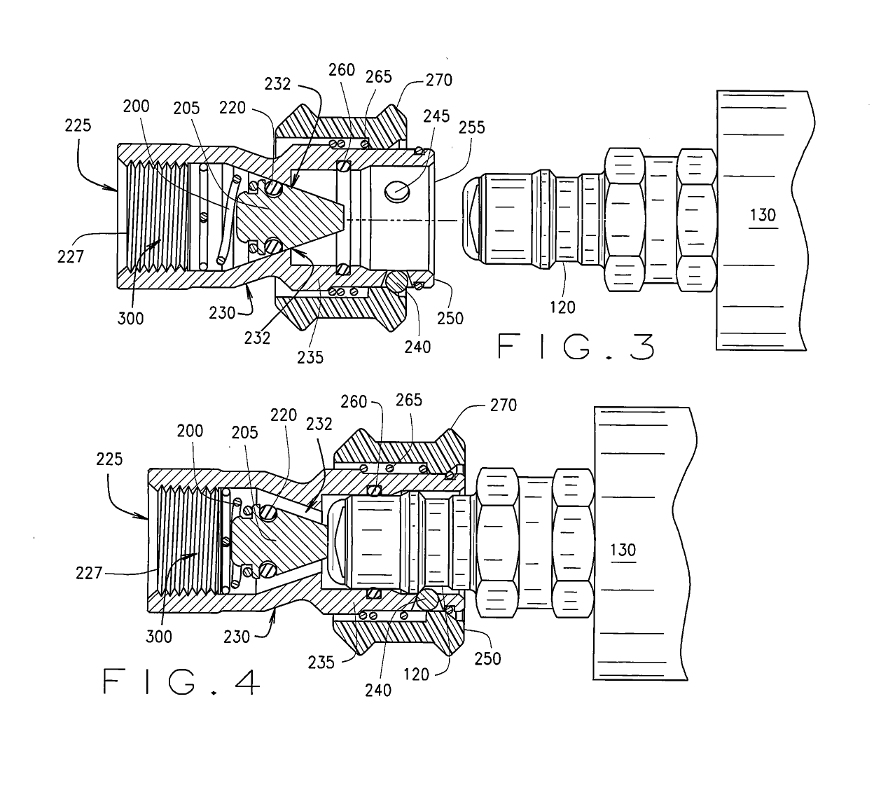

In operation, the sleeve 270 is preferably moveably positioned around the body 230, and can be moved axially along the body 230. The sleeve 270 is biased toward a first position (shown in FIG. 4) in which the sleeve 270 forces at least a portion of the ball bearings 240 into the second cavity 255. In a second position (shown in FIG. 3), the sleeve 270 no longer forces the ball bearings 240 into the second cavity 255, thereby allow the ball bearings 240 to retreat from the second cavity 255.

To connect a nozzle 120 to the quick-disconnect coupling 100, the sleeve 270 is moved into the second position such that the ball bearings 240 can retreat from the second cavity 255 when the nozzle 120 is inserted into the cavity 255. Once the nozzle 120 is inserted, the sleeve 270 is allowed to return to the first position where it forces the ball bearings 240 into the cavity 255. In the cavity 255, the ball bearings engage with a portion of the nozzle 120 therein to secure the nozzle 120 in place within the cavity 255. As can be seen in FIGS. 3 and 4, nozzle 120 preferably includes at least one channel formed therearound. In one embodiment, the ball bearings 240 are pressed down into the channel in nozzle 120, and thereby retain the nozzle 120 in place.

As mentioned above, the quick-disconnect coupling 100 is heat-sensitive for preventing the flow of gas to the gas appliance 140 when it is subjected to high temperatures. This is accomplished by forming at least one of the ball bearings 240 and/or the sleeve 270 of a suitable thermally reactive material (e.g. wax, rubber, resin, neoprene, nylon, PVC, polystyrene, polyethylene, polypropylene, polyacrylonitrile, PVB or silicone) which melts or softens when subjected to high temperatures.

It will be observed, therefore, that if the melting point of the ball bearings 240 and/or the sleeve 270 is exceeded when the quick-disconnect coupling 100 is connecting the fuel source 110 to a nozzle 120, the heat will cause the thermally reactive material to melt or soften. Where the ball bearings 240 are made of the thermally reactive material, they will soften and fail to retain the nozzle 120 in place within the second cavity 255. Where the sleeve 270 is made of the thermally reactive material, it will soften and fail to retain the ball bearings 240 at least partially within the second cavity 255, such that they fail to retain the nozzle in place within the second cavity 255. When nozzle 120 is no longer held in place within cavity 255, it no longer provides sufficient force to push the poppet 205 and poppet seal 220 away from the inner wall(s) of body 230 at through-hole 232. Poppet spring 200 then pushes poppet 205 further into through-hole 232, thereby reengaging the poppet seal 220 with the inner wall(s) of body 230 at through-hole 232. The poppet 205 and poppet seal 220 thereby act as a fuel control valve, cutting off the flow of gas to the gas appliance 140.

Thus, there has been shown and described an embodiment of a novel quick-disconnect coupling 100. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A quick-disconnect coupling comprising:
a first end having a first cavity including a socket capable of attaching the first end to a fuel source
a second end having a second cavity capable of attaching the coupling to an appliance, where said first and second cavities are in gaseous communication with one another;
a poppet member being moveable between a first position in which fuel flow between said first and second cavities is stopped and a second position in which fuel flow between said first and second cavities is allowed, said poppet member being biased toward said first position;
a securing mechanism capable of securing a nozzle within the second cavity so as to position the poppet member in its second position, said securing mechanism being thermally reactive to cease securing said nozzle within the second cavity when the securing mechanism reaches a predetermined temperature, thereby allowing the poppet member to move into the first position.

2. The quick-disconnect coupling of claim 1, wherein the socket further comprises an inner threaded passage extending radially inward in the first cavity.

3. The quick-disconnect coupling of claim 1, wherein the poppet member further comprises a cone-shaped member and a channel member.

4. The quick-disconnect coupling of claim 1, wherein the poppet is of unitary construction.

5. The quick-disconnect coupling of claim 4, wherein the poppet seal is seated in the channel member.

6. The quick-disconnect coupling of claim 1, wherein the poppet is biased toward the first position by a spring assembly.

7. The quick-disconnect coupling of claim 1, wherein the securing mechanism includes a thermally reactive sleeve.

8. The quick-disconnect coupling of claim 1, wherein the securing mechanism includes at least one thermally reactive ball bearing.

9. The quick-disconnect coupling of claim 1, wherein the sleeve is biased toward a first position moveable by a spring assembly.

10. The quick-disconnect coupling of claim 1, wherein the securing mechanism includes:
a sleeve; and
at least one ball bearing, where said sleeve selectively retains said at least one ball bearing within said second cavity to retain a said nozzle in place, thereby placing said poppet member in said second position,
wherein at least one of said sleeve and said at least one ball bearing being thermally reactive above a predetermined temperature to cease holding said nozzle in place, to allow the poppet member to return to its first position.

11. A quick disconnect coupling comprising:
a body having a securing mechanism for releasably connecting the body to an appliance;
a fuel control value housed within the body, where the fuel control valve is biased toward a closed position in which fuel flow is stopped when the body is not connected to an appliance, and where the fuel control valve is opened to allow fuel to flow when an appliance is connected to the body;
and wherein the securing mechanism is thermally reactive to disconnect the body from a connected appliance when said securing mechanism exceeds a predetermined temperature, thereby allowing the fuel control valve to close.
